(19) United States
(12) Patent Application Publication
(10) Pub. No.: US 2021/0023988 A1
(43) Pub. Date: Jan. 28, 2021

(54) EMERGENCY WARNING APPARATUS FOR VEHICLE

(71) Applicant: ChaeHyun LIM, Seoul (KR)

(72) Inventor: ChaeHyun LIM, Seoul (KR)

(21) Appl. No.: 16/578,194

(22) Filed: Sep. 20, 2019

(30) Foreign Application Priority Data
Jul. 22, 2019 (KR) 10-2019-0088297

(51) Int. Cl. B60Q 7/00

(52) U.S. Cl. CPC B60Q 7/00

(57) ABSTRACT

Disclosed herein is an emergency warning apparatus for a vehicle. An emergency warning apparatus for a vehicle according to one embodiment includes: a housing; a balloon which is placed in the upper portion of the housing, which is connected to the housing by a string, and which is expanded by introduced gas; a gas storage part which stores gas in order to supply gas to the balloon; a solenoid valve which controls a gas flow to the balloon; a main switch which operates the solenoid valve; a control unit which controls the main switch; and a main power supply which supplies power to the control unit; wherein when the main switch is operated, the solenoid valve is opened, gas is introduced from the gas storage part into the balloon, and finally the balloon rises upward and enters a state of being identifiable from a distance.

### CROSS-REFERENCE TO RELATED APPLICATION

This application claims the benefit of Korean Patent Application No. 10-2019-0088297 filed on Jul. 22, 2019, which is hereby incorporated by reference herein in its entirety.

### BACKGROUND

### 1. Technical Field

The present invention relates generally to an emergency warning apparatus for a vehicle, and more specifically to an emergency warning apparatus for a vehicle, which notifies travelling vehicles of an emergency when a traffic accident or emergency situation of a car occurs.

### 2. Description of the Related Art

When a vehicle makes an emergency stop on a road due to a road situation which may cause a traffic accident, i.e., a large defect in the surface of a road, an accident, a defect in a vehicle, or the like, an emergency warning apparatus is installed at a predetermined distance behind the vehicle having made the emergency stop in order to prevent collisions with the following vehicles.

Furthermore, when a car needs to be stopped because there is a situation in which there may occur a problem with the traveling of a vehicle, such as road maintenance or construction work, or there occurs a problem with a traveling vehicle, an emergency warning apparatus is installed. Generally, a triangular safety sign (an emergency warning triangle) is used.

Such an emergency warning triangle for a vehicle is stored in the trunk or the like of a vehicle, a safety pattern is formed on the front surface of the emergency warning triangle, support legs protruding downward are disposed on both sides of the lower end of the emergency warning triangle, and a support extending downward is rotatably coupled to the center of the rear surface of the emergency warning triangle. Generally, the emergency warning triangle for a vehicle is normally stored in a vehicle with the support brought into close contact with the rear surface of the emergency warning triangle, is installed at a predetermined distance behind the vehicle with the support set up when there occurs a problem with the travelling of the vehicle or an emergency situation occurs, and warns the following incoming vehicles of the situation. The emergency warning triangle for a vehicle is normally installed at a location 100 M or more away from the back of the vehicle for the sake of safety, and thus inconvenience is caused in that the emergency warning triangle for a vehicle must be brought back after the completion of the maintenance or the solving the problem with the traveling. The size of the emergency warning triangle for a vehicle is small, and thus the visibility power thereof is low.

In order to solve the above-described problem and inconvenience, Korean Utility Model Registration No. 20-0150554 discloses a safety sign in which lamp assemblies are located on the inclined and bottom sides of a trapezoid, a connection bar is located on the top side of the trapezoid, the vertices at which the lamp assemblies and the connection bar meet each other are connected by connection members, the center of the connection bar is back and forth rotatably fitted into a hinge fastened to the bottom surface of the back of a trunk lid, and the lamp assemblies on the inclined sides are configured to be caught on elastic brackets on both sides of the bottom surface of the trunk lid. The safety sign is stuck to the bottom surface of the trunk lid in normal times. Lamps are turned on when the trunk lid is opened, and are turned off when the trunk lid is closed. When the bottom of the lamp assemblies is lowered and the lamp assemblies are kept erect, the safety sign is set up.

Although the conventional safety sign is installed in the trunk of the vehicle, it is not easy for the following vehicles to identify the safety sign. Furthermore, the lamp assemblies are not securely fastened to the bottom surface of the trunk, but are held by the elastic brackets, and thus gaps are generated, with the result that the trunk and the lamp assemblies collide with each other due to the traveling of the vehicle and thus noise occurs.

### SUMMARY

The present invention has been conceived to overcome the above-described problems, and one embodiment of the present invention is intended to provide an emergency warning apparatus for a vehicle, which enables the following vehicles to identify an emergency situation from a distance when a vehicle breaks down on a road or causes a traffic accident during its travel, thereby preventing secondary accidents.

According to an aspect of the present invention, there is provided an emergency warning apparatus for a vehicle, the emergency warning apparatus including: a housing; a balloon which is placed in the upper portion of the housing, which is connected to the housing by a string, and which is expanded by introduced gas; a gas storage part which stores gas in order to supply gas to the balloon; a solenoid valve which controls a gas flow to the balloon; a main switch which operates the solenoid valve; a control unit which controls the main switch; and a main power supply which supplies power to the control unit; wherein when the main switch is operated, the solenoid valve is opened, gas is introduced from the gas storage part into the balloon, and finally the balloon rises upward and enters a state of being identifiable from a distance.

The balloon may be placed in the upper end portion of the housing.

The gas stored in the gas storage part may contain at least one of a luminous material or a fluorescent material.

The emergency warning apparatus may further include a check valve in order to supply gas to the balloon and to prevent gas from being discharged from the balloon.

A tube may be provided between the check valve and the solenoid valve and gas may flow through the tube.

The emergency warning apparatus may further include an auxiliary switch which is connected to the solenoid valve.

The emergency warning apparatus may further include an auxiliary power supply which supplies power in order to operate the auxiliary switch.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a schematic diagram showing an example of the operation of an emergency warning apparatus for a vehicle according to one embodiment of the present invention;

FIG. 2 is a block diagram showing the emergency warning apparatus for a vehicle according to the one embodiment of the present invention;

FIG. 3 is a schematic diagram of an emergency warning apparatus for a vehicle according to one embodiment of the present invention; and

FIG. 4 is a schematic diagram showing a state in which gas has been introduced into the balloon of the emergency warning apparatus for a vehicle according to the one embodiment of the present invention, which is shown in FIG. 3.

### DETAILED DESCRIPTION

The following embodiments are provided merely to help those skilled in the art easily understand the technical spirit of the present invention, and the present invention is not limited to these embodiments. Furthermore, the items illustrated in the accompanying drawings are items illustrated to easily describe embodiments of the present invention, and may be different from actually implemented items.

It should be understood that when one component is described as being “connected” or “coupled” to another component, the one component may be directly connected or coupled to the other component or a third component may be interposed between the two components.

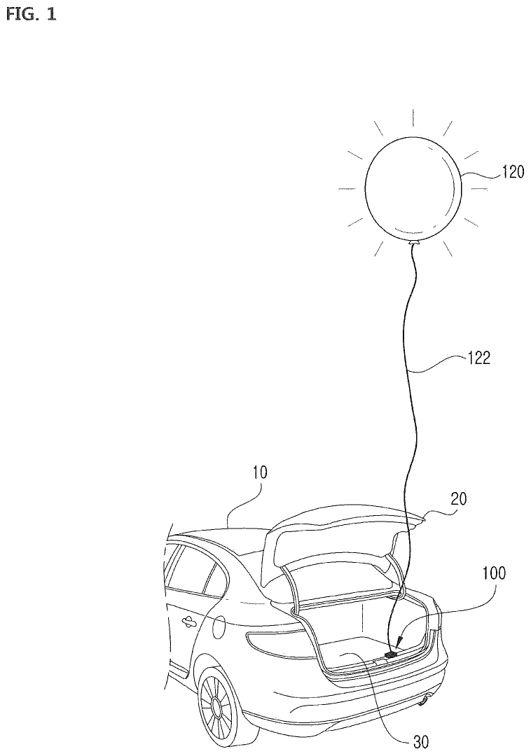

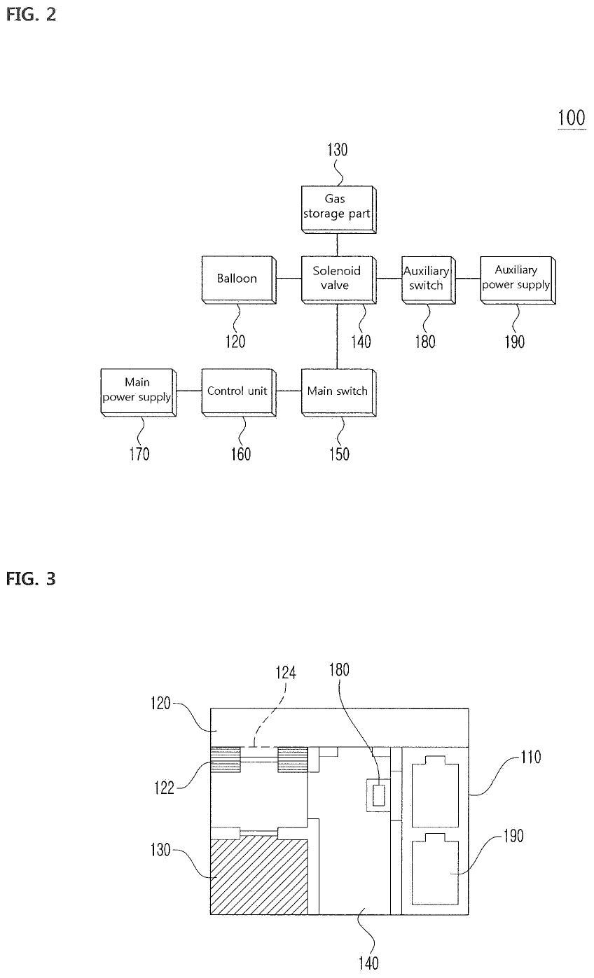

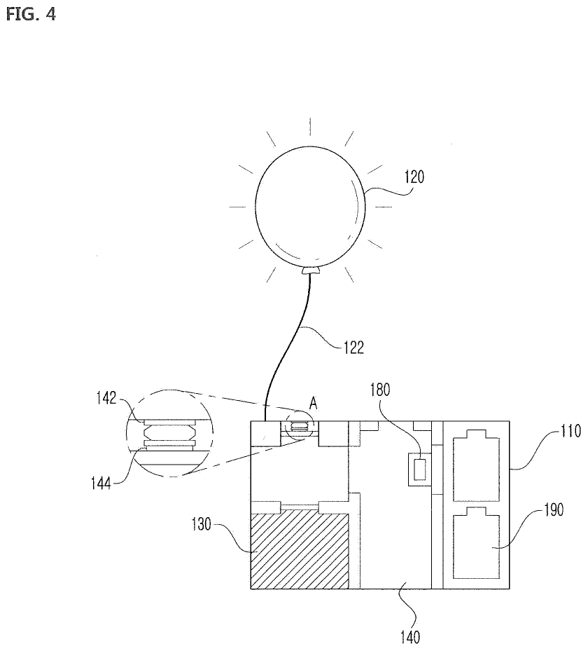

FIG. 1 is a schematic diagram showing an example of the operation of an emergency warning apparatus for a vehicle according to one embodiment of the present invention, FIG. 2 is a block diagram showing the emergency warning apparatus for a vehicle according to the one embodiment of the present invention, FIG. 3 is a schematic diagram of an emergency warning apparatus for a vehicle according to one embodiment of the present invention, and FIG. 4 is a schematic diagram showing a state in which gas has been introduced into the balloon of the emergency warning apparatus for a vehicle according to the one embodiment of the present invention, which is shown in FIG. 3.

Referring to FIGS. 1 to 4, an emergency warning apparatus 100 for a vehicle according to one embodiment of the present invention is configured to introduce gas into a balloon 120 in a state in which the trunk lid 20 of a vehicle 10 has been opened, so that the balloon 120 rises upward above the vehicle 10. In this case, the emergency warning apparatus 100 for a vehicle is located in the rear side of the trunk space 30 of the vehicle 10 which is selectively opened and closed by the trunk lid 20, and the balloon 120 of the emergency warning apparatus 100 for a vehicle is expanded by introduced gas and then rises into the air.

The emergency warning apparatus 100 for a vehicle according to the embodiment of the present invention includes: a housing 110; a balloon 120 which is placed in the upper portion of the housing 110, which is connected to the housing by a string 122, and which is to expanded by introduced gas; a gas storage part 130 which stores gas in order to supply gas to the balloon 120; a solenoid valve 140 which controls a gas flow to the balloon 120; a main switch 150 which operates the solenoid valve 140; a control unit 160 which controls the main switch 150; and a main power supply 170 which supplies power to the control unit 160. In this case, when the main switch 150 is operated, the solenoid valve 140 is opened, gas is introduced from the gas storage part 130 into the balloon 120, and finally the balloon 120 rises upward and enters a state of being identifiable from a distance. Furthermore, the balloon 120 is provided with a sealing element 124, and the sealing element 124 prevents gas, introduced into the balloon 120, from leaking.

In one specific example, the balloon 120 is placed in the upper end portion of the housing 110, has a size corresponding to that of the housing 110 based on their plan view, and rises upward when gas is introduced into the balloon 120. In this case, the gas storage part 130 supplies gas to the balloon 120, and may be connected to a check valve 142 so that gas can be prevented from leaking from the balloon 120, as shown in the enlarged view of portion A of FIG. 4. Furthermore, a tube 144 is provided between the check valve 142 and the solenoid valve 140, and allows gas to flow therethrough. In some cases, the balloon 120 may be connected to the tube 144 or solenoid valve 140 without the intervention of the check valve 142.

In this case, the check valve is a valve which is used to set the flow of gas only to a single direction. Furthermore, the check valve has a function of allowing gas to pass therethrough in such a manner that ft is opened when the pressure of the gas is low and blocking a reverse fluid flow. In other words, the check valve is configured such that when forward pressure is applied to gas, a disk or like is maintained in an opened state, and thus gas flows continuously, and is also configured such that when reverse pressure is applied, the disk is closed. The gas introduced into the balloon 120 is not discharged in a reverse direction.

According to the present invention, the gas stored in the gas storage part 130 is preferably gas which can easily raise the balloon to the air, such as helium. Furthermore, the gas stored in the gas storage part 130 may contain a luminous material and a fluorescent material. In this case, when the emergency warning apparatus 100 for a vehicle is operated, it is identifiable from a distance.

In this structure, the emergency warning apparatus 100 for a vehicle may further include: an auxiliary switch 180 which is connected to the solenoid valve 140; and an auxiliary power supply 190 which supplies power in response to the operation of the auxiliary switch 180. The auxiliary switch 180 and the auxiliary power supply 190 are configured to include a separate PCB substrate so that they can be separately operated when the emergency waming apparatus 100 for a vehicle is disconnected from the main switch 150, the control unit 160, and the main power supply 170.

In this case, the solenoid valve is selectively and automatically opened and closed by the electromagnetic force of an electromagnetic coil. Such solenoid valves include solenoid valves for steam, water, and refrigerant, and have different structures according to their usage.

Furthermore, such solenoid valves include solenoid valves of a type which is only turned on or off depending on whether or not current is supplied and solenoid valves of a type in which the amount of operation, such as a stroke, is controlled according to current intensity control. Although solenoid valves are used in various places, such as an injector, an emergency fuel shutoff device, the flow path control of a transmission valve body, etc., in vehicles, the solenoid valve used in the present invention is preferably a solenoid valve of a type which is selectively turned on and off. In connection with this, it may be possible to include a valve other than the solenoid valve and a motor configured to control the valve.

The emergency warning apparatus for a vehicle according to the present invention will be described with reference to the drawings below. The emergency warning apparatus 100 for a vehicle according to one embodiment of the present invention is configured to be located in the trunk space 30 of the vehicle 10 and to be operated when the trunk lid 20 is opened.

First, when a user operates the emergency warning apparatus 100 for a vehicle at a driver's seat, the emergency warning apparatus 100 for a vehicle is operated by pressing the main switch 150. When the emergency warning apparatus 100 for a vehicle is operated by pressing the main switch 150, the solenoid valve 140 connected to the gas storage part 130 which stores gas is opened such that gas can be supplied to the balloon 120 located in the upper end of the housing 110. When the solenoid valve 140 is opened, the gas accommodated in the gas storage part 130 is introduced into the balloon 120.

The gas is preferably helium. Furthermore, the gas contains a luminous material and a fluorescent material. Accordingly, when the balloon 120 rises to the air, it is identifiable from a distance even at night.

In this case, the balloon 120 is connected to the check valve 142, and thus gas introduced into the balloon 120 is prevented from being discharged in a reverse direction. Furthermore, the balloon 120 is provided with the sealing element 124, and thus gas is accommodated in the balloon 120 when the connection of the balloon 120 to the check valve 142 is released. The sealing element 124 is opened when gas is introduced into the balloon 120, and closes the entrance of the balloon 120 when the connection of the balloon 120 to the check valve 142 is released.

When gas is introduced into the balloon 120, the connection between the balloon 120 and the check valve 142 is released. The gas is accommodated in the balloon 120 by the check valve 142, and thus the balloon 120 rises above the vehicle 1.

The balloon 120 is connected to the housing 110 by the string, and thus the balloon 120 rises to the air by the length of the string, thereby enabling the balloon 120 to be identifiable from a remote location.

Unlike in the case where a user operates the emergency warning apparatus 100 for a vehicle at a driver's seat, when the main switch 150 fails or a user operates the emergency warning apparatus 100 for a vehicle near the trunk lid 20, the emergency warning apparatus 100 for a vehicle is operated using the auxiliary switch 180.

When the auxiliary switch 180 is pressed, the auxiliary power supply 190 supplies operating power, and thus the solenoid valve 140 is opened, with the result that the gas accommodated in the gas storage part 130 is introduced into the balloon 120. In this case, redundant descriptions of the same operations other than the operation using the auxiliary switch 180 are omitted.

As described above, when a vehicle breaks down on a road or causes an accident during its travel, the emergency warning apparatus for a vehicle according to the present invention enables the following vehicles to easily identify the emergency situation, thereby preventing secondary accidents. Furthermore, the emergency warning apparatus for a vehicle enables the emergency situation to be identified from a distance, thereby contributing to a smooth road traffic situation. Moreover, a driver may control the emergency warning apparatus for a vehicle at a driver's seat or may directly control the emergency warning apparatus for a vehicle at a location near a trunk, thereby providing convenience of use and usability.

The emergency warning apparatus for a vehicle according to the present invention has the following advantages:

First, when a vehicle breaks down on a road or causes an accident during its travel, the emergency warning apparatus for a vehicle according to the present invention enables the following vehicles to easily identify the emergency situation, thereby preventing secondary accidents.

Second, a driver may control the emergency warning apparatus for a vehicle at a driver's seat or may directly control the emergency warning apparatus for a vehicle at a location near a trunk, thereby providing convenience of use and usability.

Third, the emergency warning apparatus for a vehicle enables an emergency situation to be identified from a distance, thereby contributing to a smooth road traffic situation.

It will be appreciated by those having ordinary skill in the art to which the present invention pertains that the present invention may be practiced in other specific forms without changing the technical spirit or essential features thereof. Therefore, it should be noted that the above-described embodiments are merely embodiments selected and presented in order to help the understanding of those skilled in the art, so that the technical spirit of the present invention is not necessarily limited only to the presented embodiments, and various alterations, additions, modifications and other equivalent embodiments may be made without departing from the technical spirit of the present invention.

What is claimed is:

1. An emergency warning apparatus for a vehicle, the emergency warning apparatus comprising:
a housing;
a balloon which is placed in an upper portion of the housing, which is connected to the housing by a string, and which is expanded by introduced gas;
a gas storage part which stores gas in order to supply gas to the balloon;
a solenoid valve which controls a gas flow to the balloon;
a main switch which operates the solenoid valve;
a control unit which controls the main switch; and
a main power supply which supplies power to the control unit;
wherein when the main switch is operated, the solenoid valve is opened, gas is introduced from the gas storage part into the balloon, and finally the balloon rises upward and enters a state of being identifiable from a distance.

2. The emergency warning apparatus of claim 1, wherein the balloon is placed in an upper end portion of the housing.

3. The emergency warning apparatus of claim 1, wherein the gas stored in the gas storage part contains at least one of a luminous material or a fluorescent material.

4. The emergency warning apparatus of claim 1, further comprising a check valve in order to supply gas to the balloon and to prevent gas from being discharged from the balloon.

5. The emergency warning apparatus of claim 1, wherein a tube is provided between the check valve and the solenoid valve and gas flows through the tube.

6. The emergency warning apparatus of claim 1, further comprising an auxiliary switch which is connected to the solenoid valve.

7. The emergency warning apparatus of claim 6, further comprising an auxiliary power supply which supplies power in order to operate the auxiliary switch.
